(19) United States
(12) Patent Application Publication
(10) Pub. No.: US 2020/0250752 A1
(43) Pub. Date: Aug. 6, 2020

(54) SYSTEMS, METHODS, AND PROGRAM PRODUCTS FOR ISSUING, MANAGING, VALUING AND TRADING DIGITAL ASSET TOKENS BACKED BY A VALUE BANK COMPRISING THE RESIDUAL VALUE OF A PORTFOLIO OF GROUND LEASES

(71) Applicant: CARET VENTURES LLC, New York, NY (US)

(72) Inventor: Jay SUGARMAN, New York, NY (US)

(21) Appl. No.: 16/780,118

(22) Filed: Feb. 3, 2020

Related U.S. Application Data
(60) Provisional application No. 62/800,148, filed on Feb. 1, 2019.

(51) Int. Cl. G06Q 40/04; G06Q 20/36; G06Q 20/06; G06Q 50/16; G06Q 50/26; G06Q 10/10; G06Q 40/00; G06Q 20/38; G06F 16/27; G06F 16/23; H04L 9/06

(52) U.S. Cl. CPC G06Q 40/04; H04L 2209/56; G06Q 20/065; G06Q 50/16; G06Q 20/3678; G06Q 50/265; G06Q 10/10; G06Q 40/10; G06Q 20/381; G06F 16/27; G06F 16/2379; H04L 9/0637; G06Q 2220/00; H04L 2209/38; G06Q 20/3672

(57) ABSTRACT

Disclosed herein are systems, methods, and program products for providing Digital Asset Tokens whose value is backed by a Value Bank that has the potential for inflation-protected, tax-efficient and compounding value growth. The issuance and management of the Digital Asset Tokens are controlled by a central authority. Each Digital Token is represented by a Smart Contract on a Blockchain. Over time, the valuation of the Digital Asset Tokens increases as both (i) the Residual Value relating to existing GLs increase in value and (ii) as additional GLs are added by virtue of the Quantum Generator Model. Trading of the Digital Asset Tokens occurs via a settlement network, wherein the settlement network carries out and stores Transactions in a distributed ledger for transparency. The Digital Asset Tokens may be purchased using fiat currencies or electronic currencies, such as cryptocurrencies, via a digital Exchange.

### FIELD OF THE INVENTION

The present invention relates generally to the issuance, management, valuation and trading of digital asset tokens whose value is backed by a value bank comprising the residual value of a portfolio of ground leases relating to one or more real estate assets.

### BACKGROUND

Fiat currencies, such as the United States dollar (USD), have a decreasing value over time partly because the outstanding supply is no longer backed by an inflation resistant asset (such as gold) and additional currency is continually issued. As an example, the purchasing power (PP) of $1.00 USD has eroded to just $0.05 USD in the past 100 years. This erosion was substantially attributable to both the weakening and eventual abolition of the gold standard in the US.

Additional factors have weakened the USD over time. For example, the Federal Reserve has printed $4.5 trillion since the Great Recession began a decade ago. In addition, deficit spending has resulted in $8.4 trillion of new debt in the past decade alone. This growth in debt and, therefore, in monetary supply will likely lead to increasing inflation in the long term.

The future offers more of the same. The Congressional Budget Office (CBO) predicts that the ratio of the federal public debt/GDP will reach 150% by 2047. Further, there is a looming entitlement burden of $82 trillion of Social Security and Medicare deficits anticipated over the next three decades, which may render both programs insolvent.

The foregoing problem with fiat currencies is not only extant in the United States but occurs worldwide. As demonstrated by the following table, the purchasing power of currencies of other countries has eroded even more than that of the USD:

| | Long-term | Current PP of 1 unit |
|---|---|---|
| Country | inflation | from 1917-2017 |
| Canada (CAD) | 3.1% | 0.05 |
| Australia (AUD) | 4.0% | 0.02 |
| United Kingdom (GBP) | 4.6% | 0.01 |
| China (CNY) | 4.9% | 0.01 |

In contrast to the declining PP of the USD, real estate has consistently outperformed the USD from 1890 through 2017. In particular, a comparison between the USD and real estate using the Case-Shiller Post-Inflation Value Index indicates that real estate has outperformed fiat currencies by a factor of ˜10 (147 to 15). Outperformance was strongest during periods of high inflation.

From 2001 through 2016, returns for certain classes of real estate, such as highly walkable commercial business district (CBD) real estate (310) and highly walkable suburban real estate (259), have increased even more than overall US real estate values (212). However, all real estate, regardless of class, outperformed inflation (136) during this period.

Real estate, on the whole, is a natural inflation hedge and maintains PP over time compared to the USD. Specifically, high quality real estate coupled with motivated, investment-driven management consistently outperforms inflation in the long term. Notwithstanding the foregoing, real estate ownership currently exhibits capital inefficiencies. These have been addressed using methods developed by Safehold Inc. (SAFE).

Specifically, SAFE has developed a system that separates the ownership of the land and the building (and any other improvements) thereon. In the typical formulation of a SAFE deal, SAFE enters, as the land owner, into a ground lease (GL) with the owner of the building on a long-term basis (with a typical initial GL term extending as far as 99 years). The GL owner (i.e., SAFE) collects contractual rents from the tenant (i.e., the building owner) during the lease term. The GL owner is entitled to the return of the entirety of the real property, the building and any improvements made by the tenant thereon at the end of the GL term. The GL constitutes a unique real estate asset that provides long-dated, tax efficient ownership position in the underlying real property, while generally requiring less equity for the investment than direct fee simple ownership. As a publicly traded company, SAFE provides retail investors with investment exposure to GLs through their ownership of SAFE shares.

While the GL structure has solved certain of the capital inefficiencies relating to real estate ownership, there exists another challenge in this area. While the market appears to recognize the value of the rental income streams attributable to GLs, it does not appear to appreciate the Residual Values attributable to GLs and, in particular, to the underlying real estate properties and the buildings (and any other tenant improvements) thereon, which are returned to the GL owner at the end of a GL term.

In sum, the plurality of these residual values (with respect to a portfolio of multiple GLs) has the potential for long-term, inflation-linked and tax-efficient appreciation. However, this appreciation is not presently understood by or accessible to the market and consequently does not have the benefits of price discovery and liquidity that would arise from market access. A solution to this problem lies in the field of crypto-assets and its underlying distributed ledger technology, which have become a rapidly developing component of financial technology. Before addressing its application in the real estate context discussed above, the following provides relevant, high-level background information.

Distributed ledger technology can be used in multiple different applications but has primarily gained the public spotlight as the technological basis for cryptocurrencies, such as Bitcoin, Ether and Litecoin, among many others. In this context, distributed ledger technology enables parties that do not know each other to execute and authenticate transactions in cryptocurrencies directly without the need for a third-party intermediary such as a commercial bank or other financial institution. This achievement is made possible through the use of a decentralized, peer-to-peer network that relies on sophisticated cryptographic protocols to create and host a public ledger of all transactions (Blockchain). The Blockchain is maintained collectively on the computers of generally all of the users of the cryptocurrency or other digital assets associated with the Blockchain. The Blockchain, the digital record of all transactions, is downloaded and stored (either in whole or in part) in a decentralized manner on the computer of each Blockchain user.

The Blockchain for a given cryptocurrency includes source code governing the creation of the cryptocurrency and the cryptographic system that secures and verifies transactions in that cryptocurrency. All transactions are broadcast on the Blockchain and are recorded in “Blocks” that are added to the Blockchain, where each Block contains, among other data, details of some or all of the recent transactions not memorialized in prior Blocks and a reference to the most recent prior Block. So-called “miners” compete to solve a complex mathematical formula, and the miner that successfully solves the formula adds a Block to the Blockchain in a relatively short amount of time (e.g., 10 minutes for Bitcoin). A miner that succeeds in adding a Block receives a reward in the form of newly “minted” units of the cryptocurrency or in transaction fees.

As each Block is added to the Blockchain, the new version of the Blockchain is propagated to all the nodes on the Blockchain. The cryptographic rules and process underlying the mining system ensures that the addition of Blocks to the Blockchain is effectively irreversible. Because all transactions are recorded on the Blockchain, the “double-spending” problem (i.e., the potential for the same units of cryptocurrency to be inadvertently or intentionally used in more than one transaction) is also effectively solved. This permits direct peer-to-peer transfers of cryptocurrency without the need for a third-party intermediary to verify or otherwise intermediate transactions.

A user of the cryptocurrency possesses a private key that controls the transfer or “spending” of the cryptocurrency from its associated public Blockchain address. A Blockchain “wallet” generally refers to a collection of private keys and their associated public Blockchain addresses. Software programs can interpret the Blockchain to determine the exact cryptocurrency balance, if any, of any public cryptocurrency address listed on the Blockchain as having taken part in a transaction on that Blockchain.

Cryptocurrencies may vary substantially in the specifics of their operations, including the cryptographic protocols used for mining, the compensation mechanism for miners, the time needed for Block confirmation and the governance of the Blockchain. In fact, certain cryptocurrencies do not use the Blockchain concept specifically as described above but rather cryptographic protocols that, taken together, create a decentralized, consensus-based ledger system that is similar to Blockchain technology in that it enables rapid, peer-to-peer transfers of cryptocurrency. Ultimately, all cryptocurrencies today rely on the same basic concepts—an immutable public record of all transactions in such cryptocurrency supported by an underlying distributed peer-to-peer network associated with that cryptocurrency. For ease of reference, we refer to the foregoing concepts collectively and generally as “Blockchain technology.”

One of the key purposes of cryptocurrencies based on Blockchain technology was the creation of a digital currency that could: (i) be used to pay for goods and services (function as a medium of exchange) and (ii) serve as a store of value or as a unit of account, while at the same time providing many advantages over the traditional value transfer mechanisms used for fiat currencies, such as debit cards, credit cards and bank transfers (wire, ACH, SEPA, etc.). Specifically, transfers of fiat currencies (other than physical exchange of cash) require established financial intermediaries to facilitate and confirm the transfers, and financial intermediaries charge fees for such services. In contrast, cryptocurrencies' use of Blockchain technology permits users to transfer cryptocurrencies directly from the transferor's public address to the transferee's public address, bypassing financial intermediaries and providing a fast and comparatively low-cost method for conducting transactions.

While cryptocurrencies initially were intended to have the attributes of fiat currency (i.e., medium of exchange and store of value or unit of account), no cryptocurrency has yet managed to fulfill these functions. “Cryptocurrencies,” as commonly understood today, actually encompass numerous asset classes, including security tokens, commodity-linked tokens (e.g., tokens backed by gold) and so-called utility tokens. For precision, we refer to all tokens that are created and rely on Blockchain technology as “Digital Asset Tokens.” Over time, Digital Asset Tokens have become extremely popular, with thousands of Digital Asset Tokens (particularly security tokens) available on the market.

As noted above, a substantial amount of market interest has been piqued with respect to the use of Digital Asset Tokens as a potential alternative to traditional fiat currency payment systems and as a form of investment. But there has also been a significant amount of interest in other financial applications of Blockchain technology. In particular, there has been exponential growth in the use of so-called “Smart Contracts.” While there is no universally accepted definition of a Smart Contract, a Smart Contract can generally be thought of as a legal contract that is directly written into lines of software code that exists, in whole or in part, on a Blockchain Network.

Smart Contracts can be simple digital representations of contracts encoded onto a Blockchain Network that do not make use of the Blockchain functions beyond immutable recordkeeping. Alternatively, some Smart Contracts may self-execute predetermined contractual terms under specified circumstances. These more complicated Smart Contracts enable contract counterparties to automate (to the extent desired and practicable) the performance of contractual terms, generally to eliminate interpretive issues that may arise from manual execution and also to remove the need for any intermediary that might otherwise have been required. There are varying degrees of automated performance; some Smart Contracts may simply provide for the payment of cryptocurrency upon satisfaction of a few straightforward conditions, while others, for example, could involve highly complicated coding for multiple payment streams over time based on financial benchmarks (such as an interest rate swap).

Smart Contracts are created and exist on Blockchain Networks that are technologically capable of supporting Smart Contracts. Although the specifics of a Smart Contract would depend on how it is ultimately structured and encoded, Smart Contracts are able to take advantage of the benefits of Blockchain technology concepts, including, without limitation, (i) the issuance of a Digital Asset Token representing an interest in the Smart Contract and the capability of holding such Digital Asset Tokens in a software wallet, (ii) transparent and confirmable recordkeeping and effective irreversibility of transactions, (iii) ability to store information regarding the Smart Contract (such as information about ownership and about assets underlying the Smart Contract) and (iv) subject to applicable laws, the ability to effect seamless, peer-to-peer transfers of the Digital Asset Tokens (and thus transfer of an interest in the associated Smart Contract) without the involvement of a financial intermediary.

In 2015, Ethereum was the first Blockchain Network to support Smart Contracts. Today, while there are several Blockchain Networks capable of accommodating Smart Contracts (including the Bitcoin Network and the Blockchain Networks of Neo and Tezos), the Ethereum Blockchain Network remains the most advanced and well-developed for coding and processing Smart Contracts. In particular, an important innovation in respect of Ethereum-based Smart Contract tokens was the development of the “ERC20” protocol standard. The ERC20 protocol is a technical specification and, much like how the HTTP protocol defined the Internet, ERC20 defines a set of commands that an Ethereum-based token should implement (e.g., including the enabling of trading and transferability, determination of token balances at addresses and the total supply of tokens). Essentially, ERC20 tokens are Smart Contracts that run on the Ethereum Blockchain Network.

Smart Contracts can be used in many different applications, but one category of Smart Contracts has received the most attention as a capital raising tool for businesses. Capital raising may be accomplished through the issuance of Digital Asset Tokens that are either “Security Tokens” or “Utility Tokens.” Security Tokens refer to those Digital Asset Tokens that come within the meaning of “securities” under the U.S. Securities Act of 1933, as amended, which include Digital Asset Tokens that represent some type of interest in a business or an investment contract. In contrast, Digital Asset Tokens that are structured as Utility Tokens provide holders with use rights with respect to the issuer's goods or services (e.g., the output of a new project of the issuer) as opposed to an interest in an enterprise. While the regulation of Utility Tokens is in a state of flux, a reasonable argument can be made that certain, carefully constructed Utility Tokens should not be deemed securities under applicable law. Both Security Tokens and Utility Tokens typically are offered through initial coin offerings (ICOs). Capital raising through ICOs has exploded in popularity and according to at least one source, there have been over 1,600 known ICOs. Throughout the current specification, the term “backed” or “backed by” is used generally to refer to a circumstance in which any type of asset or interest, real (e.g., a hard asset) or virtual (e.g., a Smart Contract) is used to provide a valuation to Digital Asset Tokens. For example, a plurality of Digital Asset Tokens can be issued by an operator and be “backed by” a store of gold.

Importantly, this recent growth in Digital Asset Tokens naturally has been accompanied by the development of a complex and growing Blockchain ecosystem that includes a wide range of market participants, including, but not limited to, software developers, wallet providers, custodians, ICO platform service providers, Digital Asset Token exchanges and Digital Asset Token investment and trading firms, as well as market entities that have sought to bring this area into the more conventional financial marketplace such as LedgerX, the first CFTC-approved designated clearing organization and swap execution facility for derivative contracts on Bitcoin. These developments suggest that the market generally—encompassing the financial/investment industry, technology entrepreneurs and consumers—believes that Blockchain technology will be a long-term fixture in the fintech space.

Notwithstanding the foregoing developments, there currently has not been any application of Blockchain technology that has been designed to simultaneously achieve three key goals: (i) provide investors with investment exposure to the residual values of GLs and their potential for long-term, inflation-protected, tax-efficient and price-stable value growth; (ii) permit market forces to create price discovery and liquidity for residual values with respect to a portfolio of GLs, resolving a key market inefficiency; and (iii) leverage the benefits of Blockchain technology, such as peer-to-peer transferability and the use of a Blockchain Network for verifying and recording transactions, to further enhance market efficiency in respect of (i) and (ii) (collectively, the Objectives).

Today's Digital Asset Tokens are unable to achieve the foregoing. For example, the value of today's most well-known Digital Asset Tokens—Bitcoin and Ethereum—are based on what market participants are willing to pay for them; they neither have intrinsic value nor are backed by any asset and, in fact, have no existence apart from the Blockchain Network with which they are associated. Partly for this reason, and as a result of speculative investment, cryptocurrencies have been subject to substantial price volatility. In addition, no existing Digital Token appears to address the Objectives. Although many Digital Asset Tokens are backed by financial assets, hard assets (such as real estate) or even a combination of the foregoing, no Digital Asset Token appears to be designed to provide the market with access to, and price discovery of, an asset that today lacks price transparency and tradability. The invention described herein is not merely a form of investment but, collectively, with the various management, issuance and maintenance protocols set forth herein, provides a system that enables market access to a unique and previously undeveloped asset.

### BRIEF DESCRIPTION OF THE DRAWINGS

These and other advantages of the present invention will be readily understood with reference to the following specifications and attached drawings wherein:

FIG. 1 is a schematic diagram of a system network architecture in accordance with the present invention.

FIG. 2 depicts sample entries in a Blockchain.

FIG. 2A depicts a chart comparing risk adjusted returns vs. portfolio diversification potential for various asset classes.

FIG. 3 depicts a flowchart showing the lifecycle of a typical GL in accordance with the present invention.

FIG. 4 depicts a chart showing the cash-on-cash growing income stream of a GL versus a risk-equivalent AAA commercial mortgage-backed security (CMBS).

FIG. 5 depicts a chart showing how a GL can potentially acquire a higher ROE using fixed rate leverage.

FIG. 6 depicts a hypothetical chart showing how rent escalations built into a GL can dramatically increase the rent yield over the life of the GL.

FIG. 7 depicts a chart showing the potential exponential returns of a single asset in a Value Bank (as defined below) based on certain assumptions.

FIG. 8 depicts a chart comparing potential GL growth to TIPS.

FIG. 9 depicts a flowchart showing the establishment of a Value Bank using a plurality of GLs.

FIG. 10 depicts a flowchart showing the cyclical nature of the Quantum Generator Model.

FIG. 11 depicts a chart showing the increase of a Value Bank using the Quantum Generator Model.

FIG. 12 depicts a plurality of tables showing the increase in the price of each digital token at different hypothetical penetration rates of the total GL market.

FIG. 13 depicts a chart showing how capital additions to a Value Bank are expected to increase its value.

### DETAILED DESCRIPTION

Preferred embodiments of the present invention will be described herein below with reference to the accompanying drawings. In the following description, well-known functions or constructions are not described in detail because they may obscure the invention in unnecessary detail. For this disclosure, the following terms and definitions shall apply:

As used herein, the word “exemplary” means “serving as an example, instance, or illustration.” The embodiments described herein are not limiting but rather are exemplary only. It should be understood that the described embodiments are not necessarily to be construed as preferred or advantageous over other embodiments. Moreover, the terms “embodiments of the invention,” “embodiments” or “invention” do not require that all embodiments of the invention include the discussed feature, advantage or mode of operation.

The terms “communicate” and “communicating” as used herein include both conveying data from a source to a destination and delivering data to a communications medium, system, channel, network, device, wire, cable, fiber, circuit and/or link to be conveyed to a destination. The term “communication” as used herein means data so conveyed or delivered. The term “communications” as used herein includes one or more of a communications medium, system, channel, network, device, wire, cable, fiber, circuit and/or link.

The terms “coupled,” “coupled to” and “coupled with” as used herein each mean a relationship between or among two or more devices, apparatuses, files, circuits, elements, functions, operations, processes, programs, media, components, networks, systems, subsystems, and/or means, constituting any one or more of (i) a connection, whether direct or through one or more other devices, apparatuses, files, circuits, elements, functions, operations, processes, programs, media, components, networks, systems, subsystems or means, (ii) a communications relationship, whether direct or through one or more other devices, apparatuses, files, circuits, elements, functions, operations, processes, programs, media, components, networks, systems, subsystems or means, and/or (iii) a functional relationship in which the operation of any one or more devices, apparatuses, files, circuits, elements, functions, operations, processes, programs, media, components, networks, systems, subsystems or means depends, in whole or in part, on the operation of any one or more others thereof.

The term “data” as used herein means any indicia, signals, marks, symbols, domains, symbol sets, representations and any other physical form or forms representing information, whether permanent or temporary, whether visible, audible, acoustic, electric, magnetic, electromagnetic or otherwise manifested. The term “data” is used to represent predetermined information in one physical form, encompassing any and all representations of corresponding information in a different physical form or forms.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an email, a message, a document, a report or a list, or in any other form.

The term “network” as used herein includes both networks and inter-networks of all kinds, including the Internet, and is not limited to any particular network or inter-network.

The term “processor” as used herein means processing devices, apparatuses, programs, circuits, components, systems and subsystems, whether implemented in hardware, tangibly embodied software or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities and combinations of any of the foregoing.

Address—an identifier of alphanumeric characters that represents an origin or a destination for Transactions. Address formats used include P2PKH, P2SH, and Bech32.

Block—Transaction data that is recorded in a linear sequence over time and appended to a Blockchain, typically containing, among other data, details of some or all of the recent Transactions not memorialized in prior Blocks and a reference to the most recent prior Block.

Blockchain—a public ledger of all Transactions with respect to a given Digital Asset Token that is maintained collectively on the computers of generally all of the users of the Digital Asset Token associated with the Blockchain.

Blockchain Network—the distributed peer-to-peer network maintained in a decentralized manner in the computers of users and that underlies and supports a Blockchain.

Blockchain technology—collectively, Blockchains, Blockchain Networks and the complex cryptographic protocols used to create and maintain them.

Capitalization Rate—the potential annual income rate of return on an investment on an unleveraged basis, defined as NOI÷Cost Basis.

Combined Property Value (CPV)—with respect to a real property, the aggregate value of the land, and buildings and improvements on the land, as if there were no GL on the property.

Commercial Real Estate (CRE)—A non-residential property used for commercial profit-making purposes. Examples of CRE asset types include, but are not limited to, office buildings, multifamily (apartments), hospitality (hotels), health care, retail and industrial.

Cost Basis—with respect to a GL or the real property underlying the GL, (i) all costs associated with acquiring and owning the GL, (ii) after the acquisition of the real property underlying a GL, all costs incurred for any subsequent improvements made by the ground lessor to the real property when owned by the ground lessor and (iii) all carrying and financing costs incurred by the ground lessor and not covered by revenues from the real property.

Digital Asset Token—a digital token that is created, issued and exchanged based on Blockchain technology. Digital Asset Tokens include those issued in respect of Smart Contracts, in addition to Digital Asset Tokens backed by or whose value is otherwise linked to other asset types (e.g., commodities and securities).

Exchanges—online market or trading facilities at which Digital Asset Tokens are exchanged.

Ground Lease (GL)—a ground lease of long-term duration where the owner of the ground lease collects contractual rents from the tenant (i.e., the building owner) during the lease term and where the owner is entitled to the return of the entirety of the real property, including the building and any improvements made by the tenant thereon at the end of the GL term, generally where the rent is subject to periodic rent escalations, percentage rent participations and/or triple net terms.

Message—a virtual object created by a Smart Contract that is never serialized and exists only in the Blockchain's state.

Miner—a person or entity that participates in a Blockchain Network by adding to and perpetuating the associated Blockchain through the processing and verification of Blocks, as distinguished from other users of the Blockchain.

Operator—an entity responsible for the issuance of cryptocurrencies or Digital Asset Tokens as well as for maintaining the system governing their circulation and management. The Operator may be an economic or legal entity or any individual.

Nonce—the data field contained in a Block, the arbitrary value for which Miners seek to solve pursuant to the cryptographic protocols of the associated Blockchain.

Oracle—a collection of software protocols that identifies, verifies and collects real-world data that is external to a Blockchain Network, submits such information to the associated Blockchain for use by Smart Contracts thereon and also verifies that the Smart Contracts are being executed correctly (whether automatically or manually executed) based on the information submitted. Oracle is necessarily computer-based; however, its operation in respect of a Blockchain may be entirely automated and/or involve manual inputs from Operator.

Private Key—a set of alphanumeric characters associated with an address used to authorize Transactions from that address, similar to the function of a password.

Quantum Generator Model—refers to the growth in Residual Values, in the aggregate, in respect of a portfolio of multiple GLs through the acquisitions and originations of new GLs for such portfolio, with no additional capital required from existing holders of Digital Asset Tokens or the issuance of additional Digital Asset Tokens.

Residual Value—defined as one or more of the following: (i) in respect of a GL, at any point in time, the excess of (a) the proceeds generated by the sale of such GL (less all costs directly or indirectly associated with such sale, including, without limitation, transfer taxes, brokerage commissions and repayment of debt secured by such GL) over (b) the Cost Basis of the GL; (ii) financing proceeds from a loan specifically secured by the GL (less all costs directly or indirectly associated with such financing) in excess of the Cost Basis of the GL and after repayment of any existing debt secured by such GL and (iii) in respect of real property underlying the GL, at any point in time, the positive difference between the Cost Basis in such real property and the CPV of such property.

Security Tokens—Digital Asset Tokens that are considered securities under the U.S. Securities Act of 1933, as amended (1933 Act).

Smart Contract—a legal contract that is directly written into lines of software code that exist, in whole or in part, on a Blockchain Network and that may or may not incorporate self-executing functionality.

Transaction—a transfer of units of cryptocurrency or Digital Asset Tokens from an origin Address to a destination Address that is recorded in the associated Blockchain.

Turing Complete—computer code that contains a conditional branching construct that enables the ability to execute any type of computer application.

Value Bank—collectively, a plurality of Residual Values relating to a portfolio of GLs and the Quantum Generator Model with respect thereto.

Value Bank Database—a database containing a record of all hard assets in respect of a Value Bank.

Wallet—software or hardware used to manage Addresses and Private Keys.

System Architecture

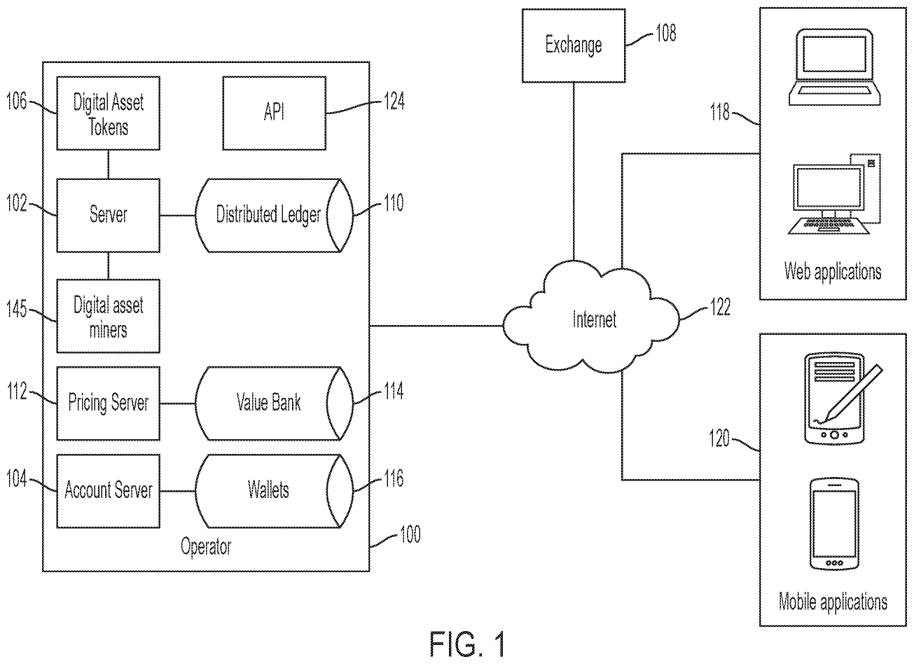

Referring first to FIG. 1, depicted is a schematic diagram of a system network architecture in accordance with the present invention. As depicted, Operator 100 preferably comprises a plurality of different servers, all of which preferably have different functions. The various depicted servers may be geographically dispersed and/or co-located. Preferably, at least the server 102 and account server 104 are embodied on a plurality of redundant computers at various locations for backup purposes. The Operator 100 is the closed part of the system and access is given solely to authorized employees of the Operator responsible for maintaining and controlling Operator 100. Specifically, Operator 100 preferably maintains the continuous functioning of the system. Server 102 is preferably responsible for the initial issuance of the Digital Asset Tokens 106 and for processing all Transactions related to Digital Asset Tokens 106 (e.g., through Exchange 108).

In one exemplary aspect, the settlement network used by server 102 is built on the basis of Blockchain technology but in a manner different from known Blockchain technologies used for the functioning of other known Digital Asset Tokens 106. In an exemplary aspect, the system of the present invention preferably uses closed technology, in which all Digital Asset Tokens' 106 issuance and transfer are under the control of the Operator 100 and, while the associated Blockchain uses public Blockchain Technology, said Blockchain is not accessible or visible by the public generally. Otherwise, the operation of the Blockchain in respect of the present invention may be similar to that of existing Blockchain systems, such as Bitcoin. The Digital Asset Tokens 106 of the present invention are therefore a kind of digital asset based upon a computer-generated mathematical and/or cryptographic protocol. Further, the Digital Asset Tokens 106 of the present invention embody Smart Contract interests in a Value Bank and will constitute Security Tokens. Thus, the Digital Asset Tokens 106 of the present invention are backed by a Value Bank.

All of the servers 102, 104, 112 supporting the present invention's Blockchain are in constant synchronization with each other and are preferably located in different data-centers, forming geographically-distributed systems and thus enhancing fault-tolerance and safety of data. Preferably, in this closed system, no reward is paid for mining. The process of generating Digital Asset Tokens 106 in the present system will not be connected with creating new Blocks in the process of the system's operation. Rather, as will be explained later, the valuation of the Digital Asset Tokens 106 will be backed by the value of assets recorded in an associated Value Bank Database 114.

The total number of Digital Asset Tokens 106 allocated for circulation in the system, according to the present invention, is preferably generated upon creation of the first Block (genesis Block) at the stage of the system's launch (primary issuance) and is preferably transferred to the pre-issuance Wallet of the Operator 100. In a preferred embodiment, the total number of Digital Asset Tokens 106 is set in a range of 5 million to 20 million. More particularly, the total number of Digital Asset Tokens 106 is preferably fixed at 10 million.

The creation of new Blocks by server 102 preferably does not incur creation of new Digital Asset Tokens 106. Rather, the creation of new Blocks is preferably for memorializing all Transactions in a distributed ledger 110 related to the purchase and sale of Digital Asset Tokens 106 by authorized entities. This gives the Operator 100 an ability to control the total number of Digital Asset Tokens 106 and use these issued Digital Asset Tokens 106 stored in the pre-issuance Wallet 116 for further issuance into the system at any time the Operator 100 prefers.

Digital Asset Tokens 106 may, among other things, be exchanged for value (e.g., fiat currency) to the extent there are Exchanges 108 in respect of the Digital Asset Token 106. The Digital Asset Tokens 106 will be a non-tangible asset that is not based upon a governmental rule, law, regulation and/or backing.

The Ethereum Blockchain is one type of Blockchain that may be used for Digital Asset Tokens 106. Other technologies that may be utilized to create and maintain the Digital Asset Tokens 106 include, but are not limited to, the Tezos and Bitcoin Blockchains.

In embodiments, the Digital Asset Tokens 106 may be based on an open source mathematical and/or cryptographic protocol, which may exist on a Blockchain Network, such as the Ethereum Blockchain. The servers forming the network of Operator 100 depicted in FIG. 1 may be centralized (e.g., run by one or more central servers) or decentralized (e.g., run through a peer-to-peer network).

Distributed ledger 110 may be maintained by a plurality of physically remote computer systems forming server(s) 102. Distributed ledger 110 tracks asset ownership and/or Transactions of Digital Asset Tokens 106. Distributed ledger 110 may be a decentralized public transaction ledger, which can be distributed to users in the network, e.g., via a peer-to-peer sharing via API 124. Distributed ledger 110 updates may be broadcast to the users across the network. Each user may maintain an electronic copy of all or part of distributed ledger 110, as described herein. In embodiments, distributed ledger 110 may employ a ledger that tracks transactions (e.g., transfers of assets from one Address to another) without identifying the assets themselves.

In embodiments, a Blockchain may be used to achieve consensus and to solve double-spending problems (i.e., where users attempt to spend the same digital assets in more than one Transaction). In embodiments, before a Transaction may be cleared and deemed final, the Transaction participants may need to wait for some period of time, e.g., a six-confirmation wait (typically one hour in the context of the Bitcoin Blockchain and 2 minutes for the Ethereum Blockchain, to name a few), before users have an acceptable measure of certainty that the Transaction is valid, e.g., not a double count. Each update to the decentralized electronic ledger (e.g., each addition of a Block to the relevant Blockchain) following execution of a Transaction may provide a Transaction confirmation. After a plurality of updates to the ledger, e.g., 6 updates, the Transaction may be confirmed with certainty or high certainty.

In general, Transactions are added to distributed ledger 110 through mining by server 102 or digital asset Miners 145. Server 102 preferably employs a proof-of-work system to verify Blocks, although a proof-of-value system may also be employed if server 102 is handled by another managed entity (e.g., a third party). Specifically, if server 102 is outsourced, the payment may be in the form of a fixed number of Digital Asset Tokens 106 for each Transaction/Block processed, although as noted above, this is not preferred in the present invention.

Referring again to FIG. 1, a Blockchain Network may include digital asset Miners 145. Digital asset Miners 145 may perform operations associated with generating or minting new digital assets, and/or operations associated with confirming Transactions, to name a few. Digital asset Miners 145 may collaborate in one or more digital asset mining pools, which may aggregate power (i.e., computer processing power) so as to increase output or control or increase the likelihood of minting new digital assets or of adding Blocks to a Blockchain, to name a few.

Server(s) 102 may have source code that may govern the activities of the servers 102. In embodiments, mining Blocks is used to confirm Transactions by adding them to distributed ledger 110 which can be updated and archived periodically using peer-to-peer file sharing technology. For example, a new ledger Block could be distributed on a periodic basis, such as approximately every 10 minutes. Each successive Block may record Transactions of Digital Asset Tokens 106 as individual Blocks in the Blockchain. Each Block may contain the details of some or all of the most recent Transactions that are not memorialized in prior Blocks.

Each server 102 may solve equations and/or add Blocks to the Blockchain. The calculator may be one or more computing devices, software, or special-purpose device, to name a few. In embodiments, in order to add Blocks to the Blockchain, a server 102 may be required to map an input data set to a desired output data set of predetermined length, such as a hash value. In embodiments, mapping may be required to use one or more particular cryptographic algorithms, such as the SHA-256 cryptographic hash algorithm or scrypt, to name a few. In embodiments, to solve or calculate a Block, a server 102 may be required to repeat this computation with a different Nonce until the server 102 generates a SHA-256 hash of a Block's header that has a value less than or equal to a current target set by Operator 100. In embodiments, each unique Block may only be solved and added to the Blockchain by one server 102.

In embodiments, the cryptographic hash function that server 102 uses may be one-way only and thus may be, in effect, irreversible. In embodiments, hash values may be easy to generate from input data, such as valid recent network Transaction(s), Blockchain and/or Nonce, but neither a server 102 nor other participant may be able to determine the original input data solely from the hash value. Other Blockchain Networks may use different proof-of-work algorithms, such as a sequential hard memory function, like scrypt, which may be used for Litecoin. As a result, generating a new valid Block with a header less than the target prescribed by the Blockchain Network may be initially difficult for a server 102, yet another server 102 can easily confirm a proposed Block by running the hash function at least once with a proposed Nonce and other identified input data.

In embodiments, a proposed Block may be added to the Blockchain once a defined percentage or number of servers 102 on the Blockchain Network confirms the Miner's work to achieve consensus. A verifier for verifying proposed Blocks may be one or more computers, software or specialized device, to name a few.

In embodiments, the mining may entail solving one or more mathematical calculations. In embodiments, the complexity of the mathematical calculations may increase over time and/or may increase as computer processing power increases. In embodiments, the result of solving the calculations may be the addition of a Block to a Blockchain, which may be a Transaction recorded in distributed ledger 110. Solving the calculations may verify a set of Transactions that have taken place.

Server 102 may timestamp Transactions through their inclusion in Blocks. In embodiments, the addition of a Block may occur periodically, e.g., approximately every 2.5 minutes or every 10 minutes, to name a few. Such Blocks cannot be changed without redoing the work that was required to create each Block since the modified Block. The longest Blockchain may serve not only as proof of the sequence of events but also records that this sequence of events was verified by a majority of the Blockchain Network's computing power. The Blockchain recognized by the nodes corresponding to the majority of computing power will become the accepted Blockchain for the network. In embodiments, confirmation of a Transaction may be attained with a high degree of accuracy following the addition of, for example, six Blocks to the Blockchain after a Transaction was performed. Because mining is controlled by server 102, cooperated attacks against the network can be avoided.

By the use of Blockchain technology, distributed ledger 110 can be used to verify the ownership and history of every Digital Asset Token 106. Further, each Transaction can be verified using distributed ledger 110, e.g., by analyzing the Blockchain, to verify the chain of ownership.

Pricing server 112 is responsible for computing the price of Digital Asset Tokens 106, using the adjusted net asset value (ANAV) calculated using pricing information about hard assets recorded in Value Bank database 112. This process will be described in more detail later.

Account server 114 is responsible for maintaining Wallets 116 which are used to trade Digital Asset Tokens 106 and/or to convert Digital Asset Tokens 106 to fiat currency (or vice versa) through interfacing with Exchanges. Each Wallet 116 stores the number of Digital Asset Tokens 106 associated with the authorized entity owning the Wallet 116. Each Wallet 116 can comprise at least one public key and at least one Private Key, e.g., based on a cryptographic protocol associated with the Blockchain system, as discussed herein. The Wallets 116 may be accessed through the Wallet 116 using the keys corresponding thereto.

A Digital Asset Token account identifier and/or a digital Wallet identifier may comprise a public key and/or a public Address. Such a Digital Asset Token account identifier may be used to identify an account in Transactions, e.g., by listing the Digital Asset Token account identifier on distributed ledger 110 (e.g., in association with one or more Transactions), by specifying the Digital Asset Token account identifier as an origin account identifier and/or by specifying the Digital Asset Token account identifier as a destination account identifier, to name a few. The systems and methods described herein involving public keys and/or public Addresses are not intended to exclude one or the other and are instead intended generally to refer to Digital Asset Token account identifiers, as may be used for other digital math-based assets. A public key may be a key (e.g., a sequence, such as a binary sequence or an alphanumeric sequence) that can be publicly revealed while maintaining security, as the public key alone cannot decrypt or access a corresponding account. A public Address may be a version of a public key. In embodiments, a public key may be generated from a Private Key, e.g., using a cryptographic protocol, such as the Elliptic Curve Digital Signature Algorithm (“ECDSA”).

In exemplary embodiments using Bitcoins, a public key may be a 512-bit key, which may be converted to a 160-bit key using a hash, such as the SHA-256 and/or RIPEMD-160 hash algorithms. The 160-bit key may be encoded from binary to text, e.g., using Base58 encoding, to produce a public Address comprising non-binary text (e.g., an alphanumeric sequence). Accordingly, in embodiments, a public Address may comprise a version (e.g., a shortened yet not truncated version) of a public key, which may be derived from the public key via hashing or other encoding. In embodiments, a public Address for a Wallet 116 may comprise human-readable strings of numbers and letters around 34 characters in length, beginning with the digit 1 or 3, as in the example of 175tWpb8K1S7NmH4Zx6rewF9WQrcZv245W. The matching Private Key may be stored in a Wallet 116 on a mobile application 120 or web application 118 and protected by a password or other techniques and/or devices for providing authentication.

In other Blockchains, other nomenclature mechanisms may be used, such as a human-readable string of numbers and letters around 34 characters in length, beginning with the letter L for Litecoins or M or N for Namecoins or around 44 characters in length, beginning with the letter P for PPCoins, to name a few.

A Private Key may be a sequence such as a number that allows the Digital Asset Tokens 106 to be transferred or spent. In embodiments, a Private Key may be kept secret to help protect against unauthorized Transactions. A Private Key may correspond to a Digital Asset Token account, which may also have a public key or other Digital Asset Token account identifier. While the public key may be derived from the Private Key, the reverse may not be true.

Preferably, every public Address has one or more matching Private Keys, which can be saved in the Wallet 116 of the account holder. The Private Key can be mathematically related to the public Address and can be designed so that the public Address can be calculated from the Private Key, but importantly, the same cannot be done in reverse.

A Digital Asset Token account, such as a multi-signature account, may require a plurality of Private Keys to access it. In embodiments, any number of Private Keys may be required. An account creator may specify the number of required keys (e.g., 2, 3, 5, to name a few) when generating a new account. More keys may be generated than are required to access and/or use an account. For example, 5 keys may be generated, and any combination of 3 of the 5 keys may be sufficient to access a Digital Asset Token account. Such an account setup can allow for additional storage and security options, such as backup keys and multi-signature Transaction approval, as described herein.

Because a Private Key provides authorization to transfer or purchase Digital Asset Tokens 106, security of the Private Key is important. Private Keys can be stored via electronic computer files, but they may also be short enough that they can be printed or otherwise written on paper or other media. An example of a utility that allows extraction of Private Keys from an electronic Wallet file for printing purposes is Pywallet. Other extraction utilities may also be used that are consistent with the present invention.

In embodiments, a Private Key can be made available to a program or service that allows entry or importing of Private Keys in order to process a Transaction from an account associated with the corresponding public key. Some Wallets 116 can allow the Private Key to be imported without generating any Transactions while other Wallets 116 or services may require that the Private Key be swept. When a Private Key is swept, a Transaction is automatically broadcast so that the entire balance held by the Private Key is sent or transferred to another Address in the Wallet and/or securely controlled by the service in question.

In embodiments, using software clients, such as Blockchain.info's My Wallet service, a Private Key may be imported without creating a sweep Transaction.

In embodiments, a Private Key may be a 256-bit number, which can be represented in one or more ways. For example, a Private Key in a hexadecimal format may be shorter than in a decimal format. For example, 256 bits in hexadecimal is 32 bytes, or 64 characters in the range 0-9 or A-F. The following is an example of a hexadecimal Private Key: E9 87 3D 79 C6 D8 7D C0 FB 6A 57 78 63 33 89 F4 45 32 13 30 3D A6 1F 20 BD 67 FC 23 3A A3 32 62.

In embodiments, nearly every 256-bit number is a valid Private Key. Specifically, any 256-bit number between 0x1 and 0xFFFF FFFF FFFF FFFF FFFF FFFF FFFF FFFE BAAE DCE6 AF48 A03B BFD2 5E8C D036 4141 is a valid Private Key. In embodiments, the range of valid Private Keys can be governed by the secp256k1 ECDSA standard used by Bitcoin. Other standards may also be used.

In embodiments, a shorter form of a Private Key may be used, such as a base 58 Wallet Import format, which may be derived from the Private Key using Base58 and/or Base58Check encoding. The Wallet Import format may be shorter than the original Private Key and can include built-in error checking codes so that typographical errors can be automatically detected and/or corrected. For Private Keys associated with uncompressed public keys, the Private Key may be 51 characters and may start with the number 5. For example, such a Private Key may be in the following format:
5Kb8kLf9zgWQnogidDA76MzPL6TsZZY36hWXMssSzNydYXYB9KF

In embodiments, Private Keys associated with compressed public keys may be 52 characters and start with a capital L or K.

In embodiments when a Private Key is imported, each Private Key may always correspond to exactly one public Address with respect to Digital Asset Tokens 106. In embodiments, a utility that performs the conversion can display the matching said public Address.

The public Address corresponding to the sample above is:
1CC3X2gu58d6wXUWMffpuzN9JAfTUWu4Kj.

In embodiments, a mini Private Key format can be used. Not every Private Key or public Address has a corresponding mini Private Key; they have to be generated a certain way in order to ensure a mini Private Key exists for an Address. The mini Private Key is used for applications where space is critical, such as in QR codes. The above example has a mini key, which is SzavMBLoXU6kDrqtUVmffv.

In embodiments, any Digital Asset Tokens 106 sent to the designated Address 1CC3X2gu58d6wXUWMffpuzN9JAfTUWu4Kj can be transferred or spent by anybody who knows the Private Key in any of the three formats (e.g., hexadecimal, base 58 Wallet format, or mini Private Key). That includes Digital Asset Tokens 106 presently at the Address, as well as any that are sent to it in the future. The Private Key is only needed to transfer or spend the balance, not necessarily to see it. In embodiments, the balance of the Address can be determined by examining the associated Blockchain.

In embodiments, a Private Key may be divided into segments, encrypted, printed and/or stored in other formats and/or other media, as discussed herein.

Wallets 116 and/or the Digital Asset Token accounts associated with and/or stored by a Wallet 116 may be accessed using the Private Key (which may be used in conjunction with a public key or variant thereof). Accordingly, the generation, access, use, and storage of Digital Asset Token accounts is described herein with respect to generation, access, use and storage of Wallets 116. Such descriptions are intended to be representative of Digital Asset Token accounts and not exclusive thereof.

The public key can be shared with others to designate the Address of a user's individual account and/or can be used by registries and/or others to track Digital Asset Token 106 Transactions involving a Digital Asset Token account associated with the Wallet 116. Such Transactions may be listed or otherwise identified by the Wallet 116. The public key may be used to designate a recipient of a Digital Asset Token Transaction. A corresponding Private Key can be held by the account holder in secret to access the Wallet 116 and perform Transactions. In embodiments, a Private Key may be a 256-bit number, which can be represented by a 64-character hexadecimal Private Key and/or a 51-character base-58 Private Key. As discussed herein, Private Keys of other lengths and/or based on other numbering systems can be used, depending upon the user's desire to maintain a certain level of security and convenience. Other forms of key pairs, or security measures can be used consistent with embodiments of the present invention.

In embodiments, a Wallet 116 may store one or more Private Keys or one or more key pairs which may correspond to one or more Digital Asset Token accounts.

In embodiments, a Wallet 116 may be a mobile Wallet, which may operate on a mobile device (e.g., mobile phone, smart phone, cell phone, iPod Touch, PDA, tablet or portable computer, to name a few). The user may access its Wallet 116 in multiple locations or across multiple platforms. For example, a user may first access its Wallet 116 on a smartphone, via mobile applications 120, and then transition or transfer the session to a web application 118 (e.g., on a laptop).

In embodiments, a Wallet 116 may be a website Wallet or a web Wallet. A user of a web Wallet may not be required to perform backups, as the web Wallet may be responsible for storage of Digital Asset Tokens 106. Different Wallet clients may be provided, which may offer different performance and/or features in terms of security, backup options, connectivity to banks or digital asset Exchanges, user interface and/or speed, to name a few.

A Transaction may require, as a precondition to execution, a Digital Asset Token signature generated using a Private Key and associated public key for the Digital Asset Token account making the transfer. In embodiments, each Transaction can be signed by a Wallet 116 or other storage mechanism of a user sending a Transaction by utilizing a Private Key associated with such a digital Wallet. The signature may provide authorization for the Transaction to proceed, e.g., authorization to broadcast the Transaction to a Blockchain Network and/or authorization for other users in a Digital Asset Token network to accept the Transaction. A signature can be a number that proves that a signing operation took place. A signature can be mathematically generated from a hash of something to be signed, plus a Private Key. The signature itself can be two numbers such as r and s. With the public key, a mathematical algorithm can be used on the signature to determine that it was originally produced from the hash and the Private Key, without needing to know the Private Key. Signatures can be either 73, 72 or 71 bytes long, to name a few.

In embodiments, the ECDSA cryptographic algorithm may be used to ensure that Digital Asset Token Transactions can only be initiated from the Wallet 116 holding the Digital Asset Tokens 106. Alternatively or in addition, other algorithms may be employed.

In embodiments, a Transaction from a multi-signature account may require digital asset signatures from a plurality of Private Keys, which may correspond to the same public key and/or public Address identifying the multi-signature Digital Asset Token account. As described herein, a greater number of Private Keys may be created than is necessary to sign a Transaction (e.g., 5 Private Keys created and only 3 required to sign a Transaction). In embodiments, Private Keys for a multi-signature account may be distributed to a plurality of users who are required to authorize a Transaction together. In embodiments, Private Keys for a multi-signature account may be stored as backups, e.g., in secure storage (which may be difficult to access) and may be used in the event that more readily obtainable keys are lost.

In some embodiments, Digital Asset Tokens 106 may be tradable on Exchange 108 (internal or external to Operator 100). Operator 100, Exchange 108, web applications 118 and mobile applications 120 are all in communication over a wide area network, such as internet 122. In particular, web applications 118, mobile applications 120 and Exchange 108 preferably interface with Operator 100 using application programming interface (API) 124.

Each web application 118 and/or mobile application 120 can be used by authorized entities to create one or more Wallets 116 which can be used for trading Digital Asset Tokens 106. Preferably, unlike other Blockchain systems, Operator 100 retains physical ownership of Digital Asset Tokens 106 at all times and the ownership of Digital Asset Tokens 106 is unalterably recorded in distributed ledger 110 for transparency. The entire contents of distributed ledger 110 are accessible via API 124 to be in compliance with any fiduciary requirements imposed on Digital Asset Tokens 106 (e.g., by the Securities and Exchange Commission (SEC)).

Authorized entities gain access to Operator 100 through the completion of a registration procedure to create a Wallet 116. Preferably copies of Wallet 116 are stored locally by web applications 118 or mobile applications 120 and at account server 104 for redundancy. As known in the art, each Wallet 116 is assigned a public Address and a Private Key used to access the Wallet 116 and/or verify Transactions.

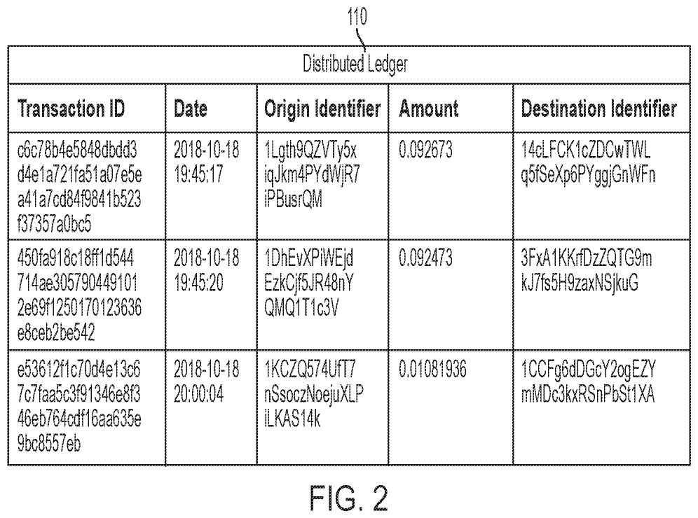

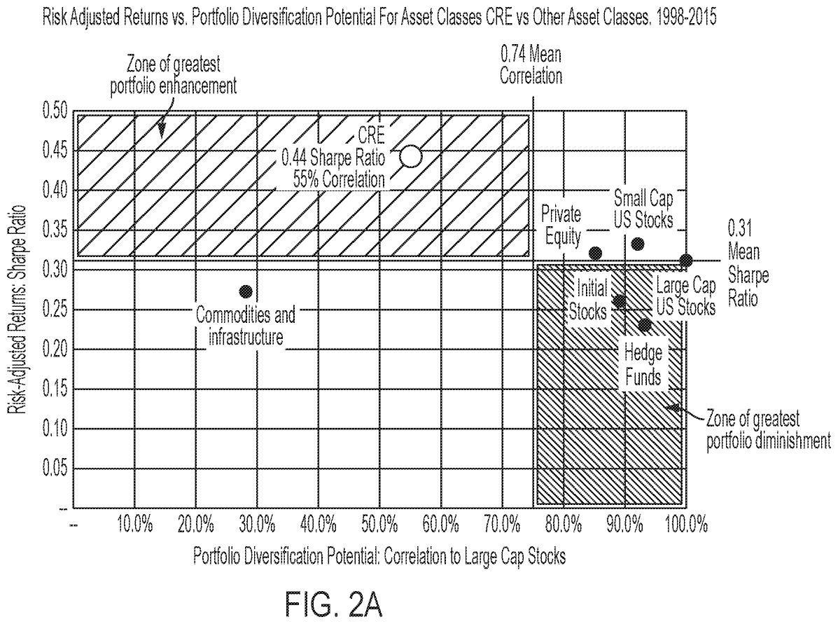

Referring next to FIG. 2, depicted are sample Transaction entries in distributed ledger 110. Each entry includes a unique Transaction identifier, a date, an origin identifier (origin Wallet), amount being transferred and a destination identifier (destination Wallet). Distributed ledger 110 may also comprise a description of information which can be used to annotate each Transaction line entry. Other forms of Transaction logs can be used consistent with the present invention.

In embodiments, a Blockchain can be used to deploy Smart Contracts within Exchange 108. Preferably, the code used in the Blockchain should be Turing Complete which will enable the system to solve any computational program. Account server 104 is responsible for authorizing which accounts may deploy Smart Contracts in the Blockchain. A Smart Contract may be an autonomous agent with its own account and Address on the Blockchain. Preferably, a Smart Contract should be able to read and write to its own internal storage (a database mapping 32-byte keys to 32-byte values), read the storage of the received Message, send Messages to other contracts and trigger execution that updates the data on the Blockchain.

The creation of a Smart Contract on the Blockchain may occur when an authorized account holder sends a Transaction to an empty Address on the Blockchain. After the Smart Contract is deployed on the Blockchain, server 102 will update the Blockchain and upload the Smart Contract's Address and embedded code to the Blockchain so that all accounts and Smart Contracts share the same data. Preferably, the contents of the Smart Contract should be made assessable to the entire Blockchain.

In embodiments, a Smart Contract may have the following purposes: maintain a data store representing something that is useful to either other contracts or accounts within the Blockchain; serve as an account that forwards incoming Messages to designated accounts only if certain conditions are met; manage an ongoing contract or relationship among accounts on the Blockchain; or provide functions to other Smart Contracts.

Generally, a Smart Contract should interact with existing accounts and Smart Contracts within the Blockchain by Transactions or Messages and may interact with computer systems outside of the Blockchain to Address certain tax, regulatory and other matters. A Message may be coded to contain a quantity of the Blockchain's token, a byte-array of data of any size and the Addresses of a sender and recipient account or Smart Contract. In general, when a Smart Contract receives a call or Message it has the option of returning some data, which the sender of the original Message can use or it can be triggered to execute its purpose subject in certain instances to the input of the Oracle.

In embodiments, generally when a Smart Contract is executed, server 102 may update the data on all accounts and Smart Contracts within the Blockchain to account for the change in the system's state. In the event that a Smart Contract's execution results in the exchange of value or information within the Blockchain, account server 104 should update the digital token balance within Wallets 116 for the appropriate accounts.

In embodiments, the Blockchain associated with the Digital Asset Tokens 106 of the present invention includes software protocols permitting constant real-time interface with Oracle. Oracle itself consists of software protocols that are distributed across the Blockchain of the present invention and connects to all Smart Contracts thereon. Oracle serves to connect, on a real-time basis, real-world data with the Smart Contract of the present invention to permit the software-automated determination of whether certain factual conditions are satisfied for the execution of said Smart Contract and, correspondingly, for the authorization of associated Blockchain Transactions. In preferred embodiments, Oracle would be created and managed by Operator 100 on a centralized basis, with real-world inputs gathered on an automated or manual basis according to parameters set by Operator.

Specifically, in respect of the present invention, Oracle may (i) accommodate multiple real-world factual data inputs necessary to assess compliance with relevant legal and tax regimes, including but not limited to U.S. (and to the extent relevant non-U.S.) anti-money laundering, securities, real estate and tax laws and regulations and (ii) incorporate relevant legal and tax compliance conditions, which are precoded into Oracle (Oracle Compliance Conditions). For example, U.S. securities laws impose numerous and complex requirements relating to the eligibility criteria for securities investors, the aggregate number of investors that may purchase Digital Asset Tokens 106 and the ability of existing holders of Digital Asset Tokens 106 to transfer them to other parties in the secondary market. As an additional example, the U.S. Internal Revenue Code of 1986, as amended, sets forth highly complex provisions governing tax implications for holders of Digital Asset Tokens 106 and Operator 100 depending on various fact patterns. On a real-time basis (either automatically and/or manually depending on the system established by Operator 100), Oracle collects factual information (a) necessary to assess whether a given Transaction should be permitted (i.e., whether the Oracle Compliance Conditions are satisfied) and (b) subsequent to the Transaction, necessary for Operator 100 to determine any legal and tax implications that may result from such Transaction. Oracle may make the foregoing determinations on an automated basis according to its precoded software and/or with further data and other inputs from Operator.

In embodiments, when a holder of Digital Asset Tokens 106 initiates a Transaction on the Blockchain of the present invention, information about the holder and the Transaction generally (including, e.g., eligibility of the transferee of the Digital Asset Tokens 106) is automatically submitted to Oracle prior to the Transaction being executed by Smart Contract. If the Oracle Compliance Conditions are satisfied, Oracle, through software protocols interfacing with the Blockchain, authorizes Smart Contract to execute Transaction (if execution is automated) or for Smart Contract to record said Transaction (if execution is manual and administered by Operator).

CRE as an Asset Class

CRE constitutes a large and important sector of the US investment market, representing 17% of the $83 trillion total of the US investment landscape, which includes $30 trillion (36%) in U.S. equities and $39 trillion (47%) in bonds and cash. The breakdown of CRE by sectors in the US is currently $2.6 trillion in multifamily, $2.5 trillion in retail, $2.2 trillion in office, $1.9 trillion in healthcare, $1.6 trillion in industrial and $1.3 trillion in hospitality.

Of the total CRE sector, approximately 58% ($8.1 trillion) is of institutional quality. Of that $8.1 trillion, approximately 20% ($1.6 trillion) is held by publicly traded REITs and 80% ($6.5 trillion) is held in private investment vehicles. Of the $1.6 trillion held in publicly traded REITs, the daily trading volume is approximately equivalent to 168% annual turnover. Of the $6.5 trillion held in private vehicles, only ˜6% of the assets are bought and sold each year. A long term migration of CRE investment to public vehicles, including those offered through Digital Asset Tokens 106, would enhance CRE liquidity and price discovery.

To the extent that CRE should be viewed as a long-term investment asset, the equity markets (when also viewed over the long term) provide a reasonable comparison to CRE. Over the past 25 years, there is evidence for the view that CRE returns have been strong relative to market benchmarks (alpha) while simultaneously uncorrelated to market benchmarks relative to other alternative asset classes (beta).

CRE “Alpha”: Outperformance vs. Market
Benchmark (1992-2017)

| | | |
|---|---|---|
| CRE Average Annual Return (A) | | 12.5% |
| Wilshire 5000 Average Annual Return (B) | | 11.6% |
| CRE “Alpha” vs. Wilshire 5000 [(A ÷ B) − | 7.7% | 0.9% |
| 1] or (A − B) | | |

CRE “Beta”: Diversification Benefit To Market Portfolio (1992-2017)

| | |
|---|---|
| Stdev of CRE Annual Returns (A) | 18.2% |
| CRE Return Relative Volatility (A ÷ B = C) | 1.0x |
| Correlation of CRE & Wilshire 5000 (D) | 52.1% |
| CRE Beta vs. Wilshire 5000 (C × D) | 0.51 |

CRE “Sharpe Ratio”: Risk-Adjusted Returns (1992-2017)

| | |
|---|---|
| CRE Average Return (A) | |
| CRE Excess Return (A − B = C) | 8.3% |
| Stdev of CRE Annual Returns (D) | 18.2% |
| CRE Sharpe Ratio (C × D) | 0.45 |

Beta combines magnitude (C) and direction (D) into a single metric that describes the sensitivity of the asset being measured to a benchmark. CRE's 0.51 beta means it has 51% of the broader market's “systemic risk.” Sharpe Ratio is a measure of risk-adjusted return, that is, reward per unit of risk (e.g., volatility expressed as standard deviation of returns). CRE's 0.45 Sharpe Ratio means it generated 0.45% of excess return per 1% of volatility. These figures support the view that CRE's performance over the past 25 years has been strong on both a standalone basis (high alpha, strong Sharpe Ratio) and portfolio context (low beta).

The chart depicted in FIG. 2A further supports the view of CRE's outperformance over competing asset classes in recent history. The chart is based on a study by CEM Benchmarking over a 17 year period from 1998 through 2015 using CEM's long-term database of investment returns for over 900 pension funds.

All of the foregoing are demonstrative of CRE's potential as a stable and valuable investment class. The Digital Asset Tokens 106 of the present invention are designed to provide market access to and price discovery for a unique investment subset of CRE. The following sets forth the basic investment construct, Ground Leases (GLs), that serve as the basis for this subset.

Ground Leases (GLs)

Historically, investors in real property have had to buy two different investments with very different investment characteristics: the building and the land. Assume a building investment has a 5 to 10 year holding period, requires active management and has a hypothetical return on equity (ROE) of ˜20%. In contrast, assume the land investment requires little to no management (passive management) and has a long-term holding period but a smaller but stable ROE of ˜5%. These two assets possess distinct and fundamentally different investment characteristics. Holding both simultaneously is not necessarily the most efficient investment methodology.

GLs are designed to separate the land from the building. A GL generally represents ownership of the land underlying a CRE property that is triple net leased on a long-term basis by the GL owner to a tenant that owns and operates the building. During the GL term, the tenant is responsible for all operating costs and improvements. The GL owner collects rent payments during the lease term. At the end of the GL term or upon a tenant default, the land and building, including all improvements, revert back to the GL owner.

The GLs have the following positive investment attributes for the GL owner:
Senior position in the capital structure
Senior priority of rent payment
Contractual rent escalators, which are built into the GL with adjustments based on the Consumer Price Index, increase income over time
Rent bumps can be amplified with leverage
In-built inflation hedging component given the nature of real estate
Growing rent stream and reversion rights at GL expiration provide an opportunity for significant capital appreciation
Property values expected to compound in value over life of the GL

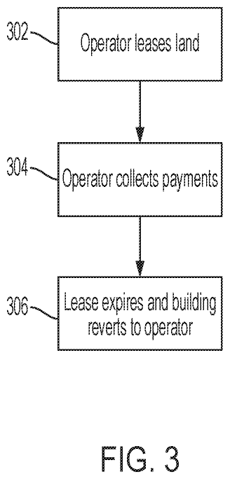

Taking into account the foregoing, one could reasonably view the GL as the safest type of real estate investment. FIG. 3 depicts the lifecycle of a typical GL in accordance with the present invention. After the GL has been established and the terms have been agreed to, the Operator 100 leases the land to the tenant on a triple net lease basis in step 302. The tenant is responsible for operating the building(s) for the duration of the lease term and making any needed improvements. In step 304, the Operator 100 collects ground rent payments, typically including contractual escalations and/or percentage rent payments during the lease term. Then, in step 306, at lease expiration, or upon a tenant default, Operator 100 continues to own the land, and the title to all improvements thereon reverts to the Operator 100. GLs can also be extended throughout the duration of the lease term, subject to the specific GL terms.

GLs lower the overall cost of capital for real estate. As a result, CRE investors utilizing GLs would need to invest less equity per asset, which would allow for diversification into other CRE assets while possibly earning greater returns on that equity. Assume, for example, a $100 million dollar CRE investment with a $5.25 million net operating income (NOI) and 5.25% cap rate. Hypothetically, an investor seeking fee simple ownership would inject $25 million of equity and take a $75 million agency loan with a 10-year term (with 2 years being interest-only (I/O)), resulting in a 75% loan-to-value ratio (LTV). In this assumed scenario, there would be a debt service coverage ratio (DSCR) of 1.41 times, 6.2% cash return and an internal rate of return (IRR) of 13.0%.

Compare, however, a hypothetical GL on that same property. Assuming a $35 million GL with a 4.0% initial yield, the investor would only need to provide $16.9 million in equity and obtain a $48.1 million agency loan (75% leasehold LTV) with a 10-year term (2 years I/O). Thus, the same purchase price would need less equity ($16.9 million); obtain a better DSCR on leasehold loan (1.62 times versus 1.41 times), on a levered basis; provide better cash-on-cash returns to equity (8.7% versus 6.2%); and provide better IRRs (17.7% versus 13.0%). Assuming no change in the cap rate, a GL's IRR would be 17.7%, 470 bps in excess of the 13.0% IRR attributable to fee simple ownership.

Not all GLs are necessarily equal in their investment characteristics and quality. GLs are misunderstood and not prevalent because the GL investor base historically has been small and over-weight towards non-institutional private groups, which have structured GLs in ways that are not necessarily customer-friendly. For example, many current GLs are written with periodic fair market value (FMV) resets which could be multiples of prior GL rent. These characteristics may result in uncertainty for the GL tenants, their lenders and future buyers, result in an inability to optimize assets during the GL terms and also produce a less certain rental income stream for the GL owner. In addition, there generally is a lack of a broker ecosystem in respect of GLs to educate property owners and make deals, because there is little incentive for brokers to focus on GLs even though brokers are involved in the majority of CRE transactions.

The GLs relevant to the present invention are fundamentally different from historical GLs in three critical respects: (i) clarity, (ii) visibility and (iii) flexibility. This is achieved by eliminating FMV rent resets, utilizing fixed or capped rent bumps, right sizing GL rents at 3-5× coverage, providing GL tenant flexibility to improve or alter premises of GL and clearly outlining GL tenant rights. This provides the GL tenant with the ability to optimally raise equity and debt capital in respect of the property, as well as an incentive to invest in the asset and make capital and operating decisions with a long-term view, which in turn would, over the long term, also inure to the benefit of the GL owner, who is entitled to the return of the asset and any improvements thereon at the end of the GL term. In addition, GLs provide the GL owner with comparative certainty in respect of its rental stream for the duration of the GL.

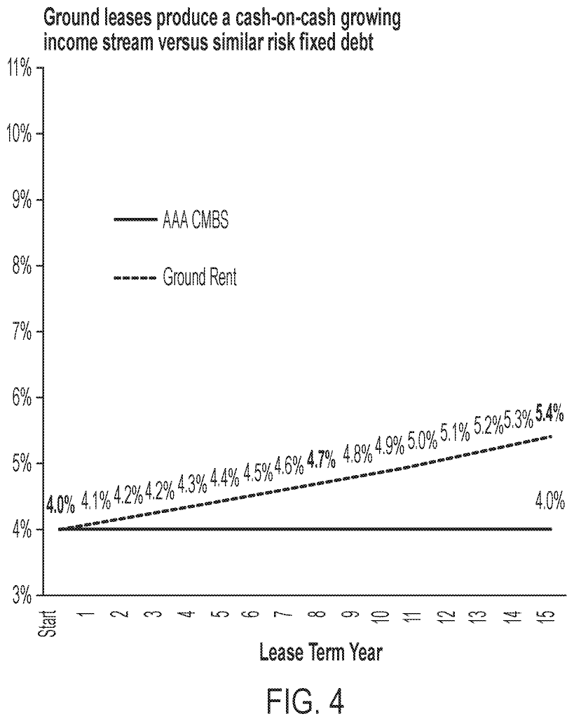

As a result of these characteristics, GLs that split ownership of the land and building have the potential for attractive growth. FIG. 4 depicts a chart showing a hypothetical cash-on-cash growing income stream of a GL versus a risk-equivalent AAA commercial mortgage-backed security (CMBS). As shown, the GL unlevered ROE increases due to in-built, fixed rent-increase provisions. For example, at year 15, while the unlevered ROE of the AAA CMBS remains at 4.0%, the unlevered ROE for the GL incrementally increased from 4.0% to 5.4%.

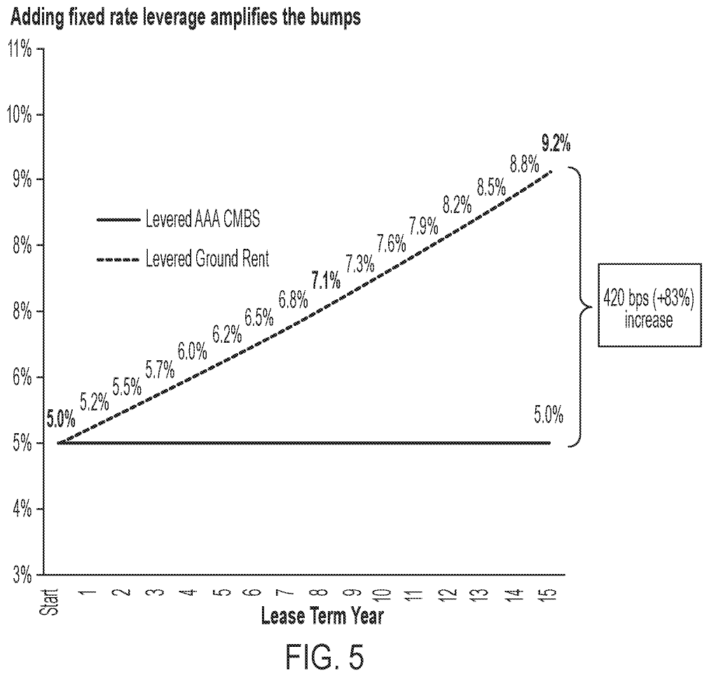

FIG. 5 depicts how such a GL could potentially generate even higher ROE by adding fixed -rate leverage to the GL, which could potentially increase the year 15 ROE for the GL from 5.4% (as set forth in FIGS. 4) to 9.2%.

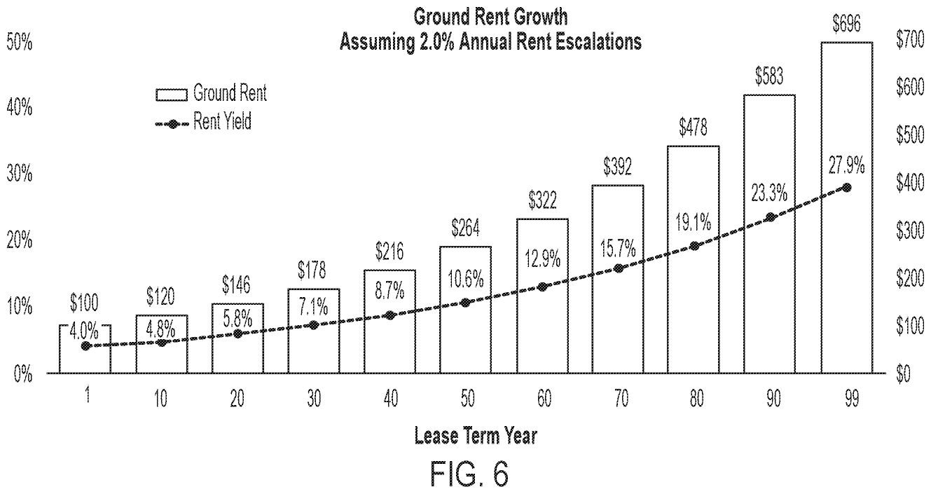

FIG. 6 depicts a chart showing how rent escalations built into a GL can increase the rent yield over the life of the GL. For example, assuming 2% annual rent escalations, the rent yield increases from 4.0% to 27.9% over the typical 99-year term of a hypothetical GL.

Value Bank

A portfolio of GLs, as discussed above, support a Value Bank 114 in an embodiment of the present invention. A Value Bank 114 has the potential to provide long-term, tax-efficient and compounding value growth in real property through GLs. Because it is tied to CRE, which has strong performance generally and also outperformance over inflation (as discussed above), a Value Bank 114 is expected to share those characteristics. As a long-term asset tied to CRE, a Value Bank 114 has the potential for price stability. In addition, a Value Bank benefits directly and indirectly from the positive investment attributes of a portfolio of GLs (described in Paragraph 148 above). For example, in respect of a given real property, under a GL with a structure employed by Operator 100, the leasehold owner remains highly incentivized to increase the value of the property (CPV), which in turn increases the potential Residual Value that comprises the Value Bank.

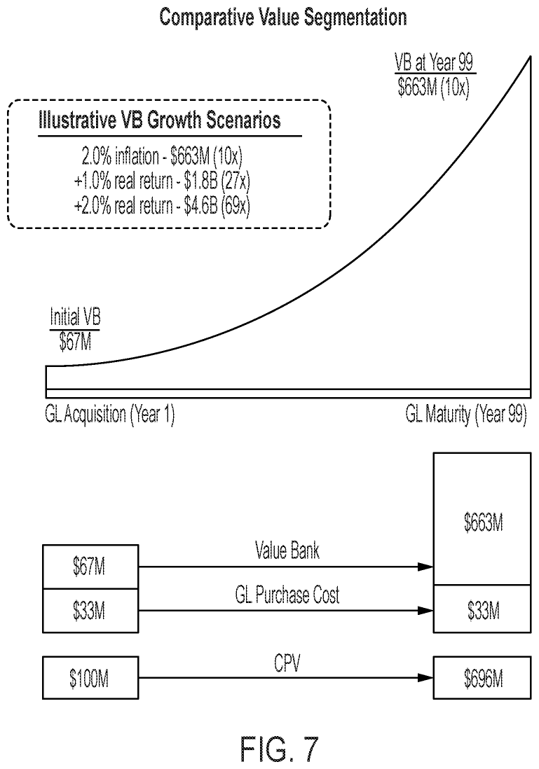

FIG. 7 depicts the calculation of a single asset's possible Residual Value in Value Bank 114. In this illustrative example, a current calculation of a Residual Value of the single asset is $67 million, a CPV of $100 million (at year 1) and a GL cost of $33 million. Assuming the maturity of the GL for the single asset in the underlying portfolio at year 99, the hypothetical Residual Value would be as follows: $663 million assuming 0% real return above 2% inflation, $1.8 billion assuming real return of 1% above 2% inflation and $4.6 billion assuming real return of 2% above 2% inflation.

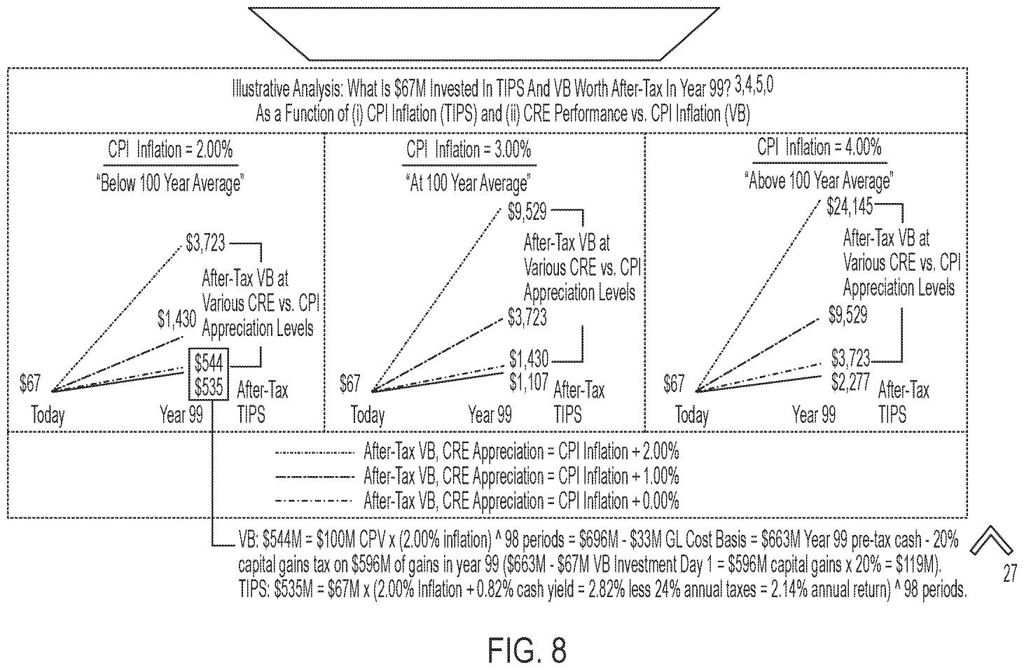

Another advantage of a Value Bank 114 is its growth potential on a tax-deferred basis. FIG. 8, which uses the initial and growth figures of FIG. 7 as its premise, depicts a chart comparing a single asset's initial Residual Value of $67 million in Value Bank 114 compared to US Treasury Inflation-Protected Securities (TIPS) when held in a taxable account, assuming 0.82% cash yield on 30-year TIPS with annual 24% federal income tax on cash yield and non-cash CPI adjustments to principal. The 99-year period for the TIPS is created by reinvesting 30-year maturities on a rolling basis. For the single asset in Value Bank 114, the chart assumes tax-deferred growth with 20% capital gains due in year 99 (expiration of GLs). In all the depicted scenarios, the after-tax valuation of the Residual Value of the single asset in the Value Bank 114 is significantly higher than that of the TIPS investment.

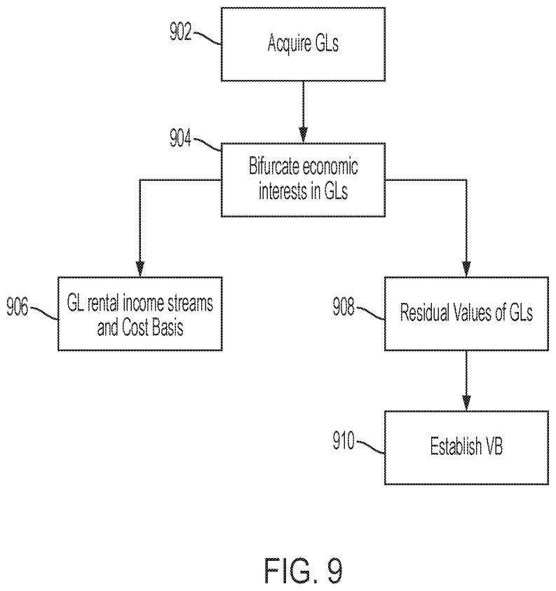

FIG. 9 depicts the steps utilized to establish and maintain Value Bank 114. In step 902, a plurality of GLs are acquired by Operator 100. The Operator 100 then bifurcates the GLs into separate classifications in step 904: (a) GL rental income streams and Cost Basis (step 906) and (b) the economic interests in Residual Values of the GLs (step 908). The Residual Values of the GLs are used to establish and value the Value Bank 114 in step 910. The valuation of the Value Bank 114 can then be grown over time as will be described later (i.e., additional GL acquisitions).

Taken collectively, FIGS. 4-9 demonstrate that, even with relatively conservative assumptions as to CRE returns, a pool of structured GLs having in-built protections for inflation and the characteristics of a GL using Operator's structure, can significantly support a Value Bank 114 that potentially substantially increases in value over a long-term period.

In addition to the foregoing, a Value Bank 114 also has the potential to serve as a more effective store-of-value (SOV) over time when compared to other assets that are typically viewed as having SOV characteristics. Compare, for example, gold, which is in many contexts viewed as a SOV asset class. With only 8% of gold used for industrial purposes, and no intrinsic cash flow to support its value, gold's appeal as a SOV asset relies primarily on investor-faced sentiment.

Another SOV asset class, oil, while cash-flow based, is subject to high volatility and potentially significant declines in use in the future. Currently, 71% of oil is used for transport and petroleum is currently 92% of the energy source used for transport. However, electrical vehicles (EV) could rise to 54% of vehicle sales by 2040, which would greatly impact oil prices. Underlying factors driving EV adoption over the coming years include: (1) short-term regulatory support in key markets (US, Europe and China), (2) falling lithium-ion battery prices, (3) increased EV commitments from automakers, (4) growing consumer acceptance, driven by competitively priced EVs across all vehicle classes and (5) the growing role of car sharing, ride hailing and autonomous driving. These factors could undercut oil's value as a SOV asset.

In comparison to these SOV assets, a Value Bank 114, as supported by a diversified portfolio of GLs, has potential as an effective SOV asset because of its potential for inflation-hedged, price-stable, tax-deferred value growth over long-periods of time, all as discussed above.

Digital Asset Tokens of the Present Invention; Transactions

Today, there appears to be no method for obtaining investment exposure to a Value Bank 114. Consequently, there is a lack of price discovery with respect to Value Banks 114 and the market is prevented from recognizing and taking advantage of a long-term asset with significant growth potential. In the present invention, an Operator 100 that owns a portfolio of GLs may issue Digital Asset Tokens 106 whose value is backed by a Value Bank 114 corresponding to those GLs. These Digital Asset Tokens 106 would be securities under the 1933 Act, but subject to those laws, would be transferable from one holder to another in a peer-to-peer fashion through application of Blockchain technology as discussed above under System Architecture.

Quantum Generator Model

The examples described in FIGS. 4-8 depict the potential for long-term growth presented by a Value Bank 114 of an assumed, fixed value over time. However, it is expected that Operator 100 will be able to enter into additional GLs as the increase in the value of Digital Asset Tokens 106, allowing Operator 100 to access additional capital on a cost-effective basis; the fact that additional GLs, to the extent that they are entered into by Operator 100, will be added over time to the GL portfolio (the Residual Value of which underlies a Value Bank) 114 without the sale of any additional Digital Asset Tokens 106. Using this construct, Value Bank 114 growth can be accelerated as more specifically described below in paragraphs [0170]-[0173].

Specifically, the present invention introduces a fixed number of Digital Asset Tokens 106 (already described) that can be purchased by, and traded among, authorized entities. In some drawings, the Digital Asset Tokens 106 are referred to as “CARETs.” This cyclical process for increasing the value of a Value Bank 114 is referred to herein as the “Quantum Generator Model.” The Quantum Generator Model does not require any additional capital investment from the Operator 100 and does not permit the generation of additional Digital Asset Tokens 106 after the initial generation.

As already described, the Operator 100 is assumed to own a plurality of GLs (Value Bank 114). Shares for the Operator 100 are preferably traded via a stock market exchange, such as the NYSE and/or NASDAQ. The Operator 100 also has generated a fixed number of Digital Asset Tokens 106 utilizing the system depicted in FIGS. 1-2, of which Operator 100 preferably holds a substantial majority.

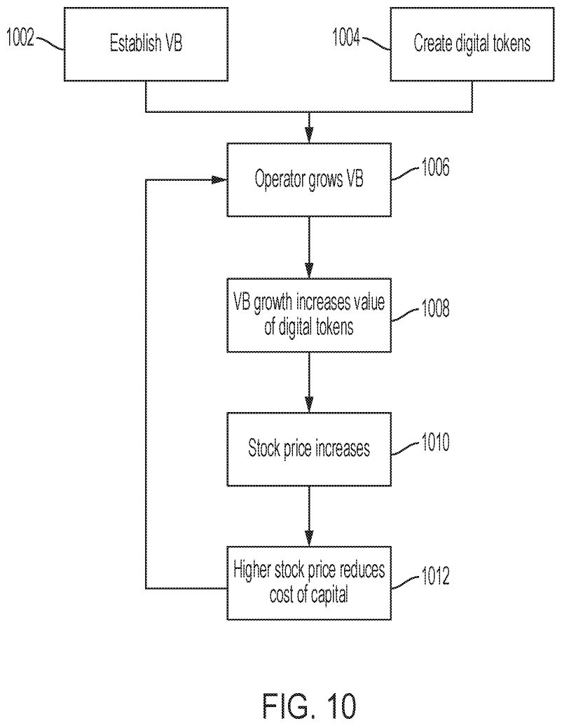

FIG. 10 depicts a flowchart showing the cyclical nature of the Quantum Generator Model. In step 1002, Operator 100 establishes a Value Bank 114 using an initial capital investment (with a plurality of GLs). The Operator 100 also utilizes server 102 to create a fixed number of Digital Asset Tokens 106 in step 1004 (e.g., 10 million Digital Asset Tokens 106) and preferably maintains ownership of a substantial majority thereof. The price of each Digital Asset Token 106 is related to the valuation of the assets held in a Value Bank 114 as the Value Bank 114 provides the backing for Digital Asset Tokens 106.

The Operator 100 continuously grows Value Bank 114 through GL acquisitions and originations in step 1006, wherein the Residual Value of the newly acquired GL is added to the Value Bank 114. The increase in Value Bank 114 in step 1006 leads to an increase in the value of each Digital Asset Token 106 owned by Operator 100 in step 1008. The increased value of both Value Bank 114 and Digital Asset Tokens 106 increases the stock price of Operator 100, increasing its valuation in step 1010. The higher stock price of Operator 100 reduces the cost of capital and allows more GL acquisitions in step 1012. And, as already stated, the addition of GLs again grows Value Bank 114 (step 1006 again).

In the cycle of steps 1006-1012, referred as the Quantum Generator Model, the Operator 100 contributes 100% of Value Bank 114 interests from new GL acquisitions/originations to a Value Bank 114 without the existing holders of Digital Asset Tokens 106 being required to invest any capital (other than the initial purchase or acquisition price). Because the number of Digital Asset Tokens 106 is fixed, the growth in a Value Bank 114 drives its trading price. The increase in the price of the Digital Asset Tokens 106 also increases the stock price of Operator 100 and lowers its cost of equity. The reduced cost of capital can be leveraged as an advantage in acquiring and originating new GLs.

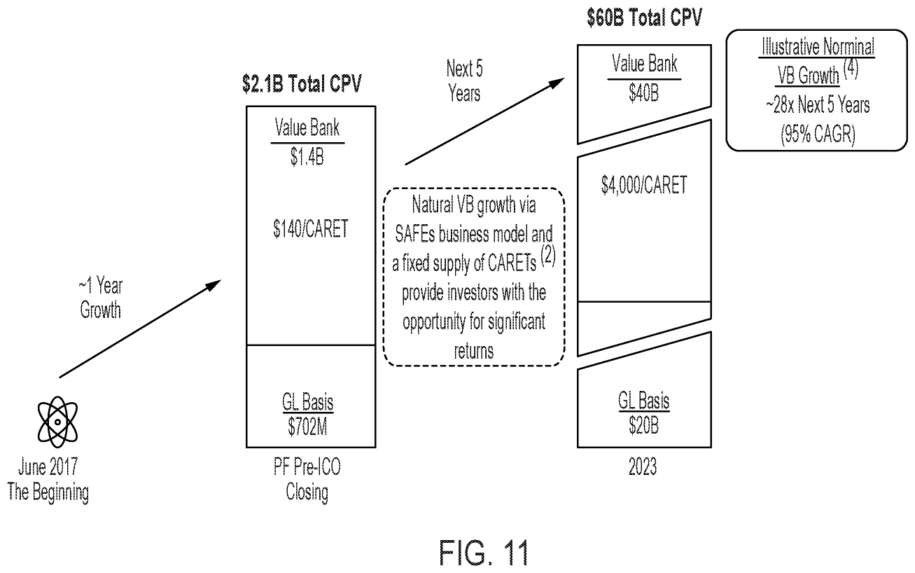

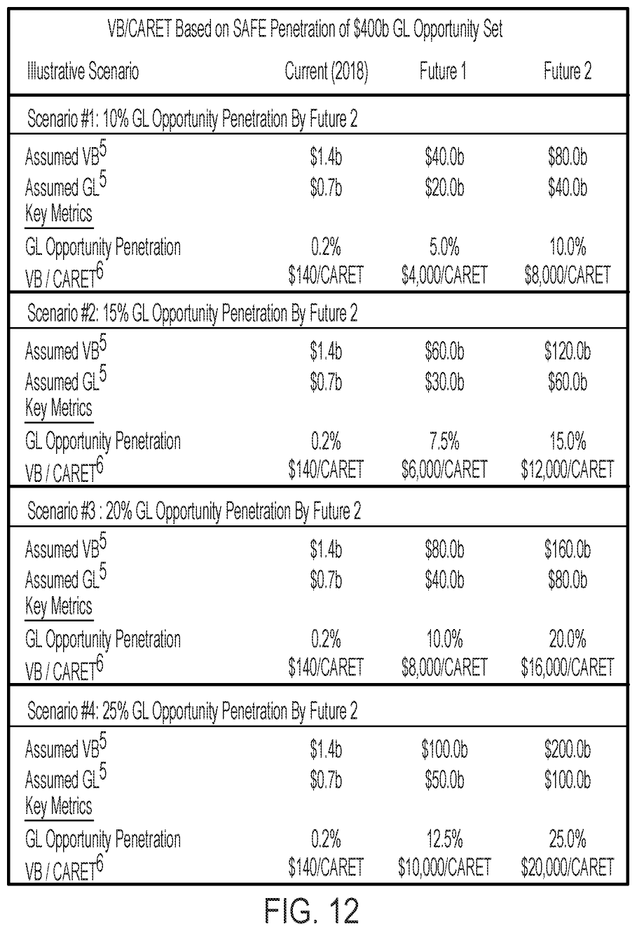

In some embodiments, the Quantum Generator model may function without Digital Asset Tokens 106. Instead, Operator 100 may issue securities that allow individual or institutional investors access to Value Bank 114. In this embodiment, server 102, created and maintained by Operator 100, using computer-based systems developed by Operator 100, would be responsible for issuing the securities and implementing the components of the Value Bank 114 and Quantum Generator model in respect of the securities as described above. As GLs are added to the Value Bank 114, pricing component of server 112 would, in real time, inform server 102 of the new GL valuation information that would then be made available to all holders of the securities. In addition, server 102 can be used to record all ownership and trading of the securities as well as monitor the trading price in real-time. Server 102 can also function, both with automatic and manual inputs from Operator 100, to record ownership (initial and subsequent holders) and simultaneously assess whether transfers of the securities are permitted according to applicable legal and tax requirements by performing the functions of Oracle as described above. In effect, server 102 with all related software protocols, as created and maintained by Operator 100, may implement all aspects of present invention without the use of Digital Asset Tokens 106, although certain of the benefits of Blockchain Technology (e.g., cryptographic security) may not be available in this embodiment. FIG. 11 depicts an example of the potential increase in value caused by applying the Quantum Generator Model to a Value Bank 114. For example, assuming that after a year of growth, the hypothetical Value Bank 114 of Operator 100 has a value of $1.4 billion and a GL basis of $702 million for a total CPV of $2.1 billion. Assuming that a total of 10 million Digital Asset Tokens 106 are issued by server 102 in a genesis Block as an initial coin offering (ICO), the value of each Digital Asset Token 106 would be $140 (e.g., $1.4 billion/10 million). By applying the Quantum Generator Model to the Value Bank 114 over a 5 year period, the value of the Value Bank 114 can be increased to $40 billion, resulting in an imputed price increase for the Digital Asset Tokens 106 from $140 to $4000. At the same time, the portfolio of GLs is increased from $702 million to $20 billion. This represents a total growth of 28× for the Value Bank 114 in a period of five years, a compound annual growth rate (CAGR) of 95%. FIG. 12 illustrates a plurality of tables showing the increase in the price of each Digital Asset Token 106 at different penetration rates of the total GL market by Operator 100. As shown, even with a penetration rate of only 10%, the price of each Digital Asset Token 106 is increased from $140 to $8000. However, if a 25% penetration rate is achievable, the value of each Digital Asset Token 106 can be increased to $20,000.

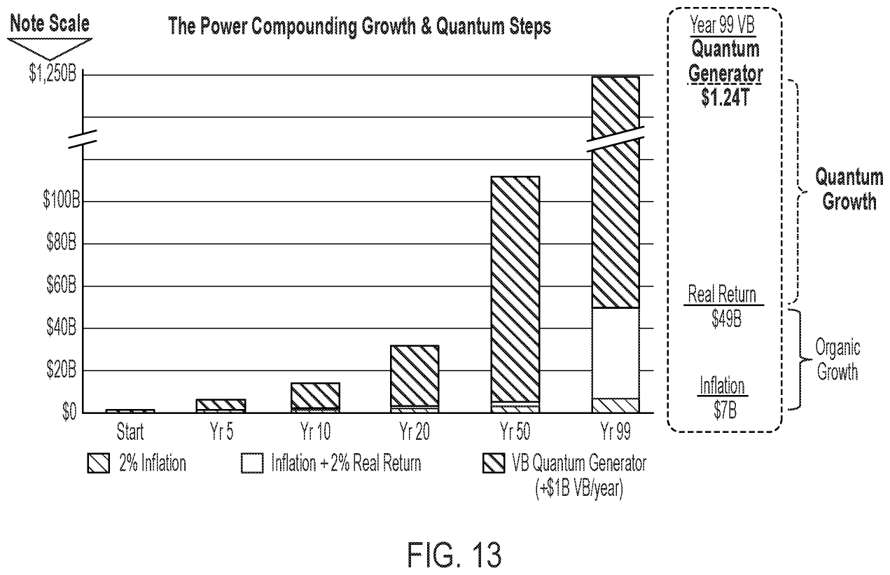

As another example, FIG. 13 illustrates a chart showing how the addition of $1 billion per year to a Value Bank 114 exponentially increases the Value Bank 114 over a standard GL lease term (99 years). Without the additional investment, assuming 2% inflation and 2% real return, the Value Bank 114 would have a value in year 99 of $49 billion. However, with the additional contributions to the Value Bank 114 from the Quantum Generator Model, the total value of the Value Bank 114 in year 99 would be $1.24 trillion. The Value Bank 114 by itself provides a unique, institutionally sponsored, self-generative store of value based on hard assets. The Value Bank 114 has the ability to compound substantially via a combination of organic growth and future contributions.

By tying a Value Bank 114 to a plurality of Digital Asset Tokens 106, this democratizes access to this market, allowing users without significant capital to participate in the growth of the Value Bank 114. Also, using a Value Bank 114 as backing for the Digital Asset Tokens 106 provides a much easier and more familiar path for users of fiat currencies to transition assets into the crypto-ecosystem. Further, because all Transactions regarding Digital Asset Tokens 106 are controlled by Operator 100 based on a Blockchain, there is increased transparency and security due to the security provided by distributed ledger 110.

Uses of the Digital Asset Tokens and Related Concepts

Digital Asset Tokens 106 can also potentially serve as a purchasing-power-parity coin complementing cryptocurrency and fiat currency exchanges. For example, consumers may choose to monetize a portion of their Digital Asset Tokens 106 into various cryptocurrencies and/or fiat currencies depending upon market conditions.

In other scenarios, the Operator 100 may issue a plurality of classes of Digital Asset Tokens 106, with each class being focused on a particular portfolio or risk type. For example, a first Value Bank 114 and fixed number of Digital Asset Tokens 106 may be issued for a “Pacific Northwest” Value Bank 114 in which all the GLs originate from the PNW. Classes can also be based on risk, region, asset type or even special themes such as “climate change.”

The above-cited patents and patent publications are hereby incorporated by reference in their entirety. Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the invention may therefore be practiced otherwise than as specifically described above.

What is claimed is:

1. A computer-based system for issuing and managing Digital Asset Tokens, comprising:
(a) a management module, executed by a computer processor, configured to:
(i) create and manage one or more Wallets of Digital Asset Tokens for a system Operator and a plurality of clients;
(ii) execute electronic currency payment Transactions by transferring Digital Asset Tokens between one or more Wallets of the system Operator and/or a plurality of clients and recording information about the executed Transactions in a distributed ledger of a private Blockchain-based settlement network;
(iii) manage information about a Value Bank backing the Digital Asset Tokens; and
(b) an issuance center, executable by a computer processor, configured to:
(i) receive, in real-time, value information from the management module concerning the Value Bank,
wherein the value information comprises the difference between a Cost Basis of a plurality of Ground Leases held in the Value Bank and a Combined Property Value of real estate assets related to the Ground Leases held in the Value Bank;
(ii) incorporate an Oracle to receive, in real-time, real-world data inputs necessary to assess compliance with relevant legal and tax regimes and, through precoded software protocols, determine whether a given Transaction meets legal and tax compliance conditions such that it may be executed by a Smart Contract; and
(iii) perform centralized generation and controlled issuance of the Digital Asset Tokens into circulation,
wherein the generation of all of the Digital Asset Tokens is performed in a single Block by creating this Block in a Blockchain using a mining operation that generates a fixed number of Digital Asset Tokens, and
wherein a real-time value of the Digital Asset Tokens is based on the real-time value information from the management module.

2. A computer-implemented method for valuing Digital Asset Tokens comprising the steps of:
(a) providing a Value Bank, which is comprised of the Residual Value imbedded in a portfolio of GLs as the same is further enhanced by the application of a Quantum Generator Model;
(b) determining a Combined Property Value of the one or more real estate assets in the Value Bank;
(c) providing real time portfolio metrics and characteristics that influence the Combined Property Value;
(d) determining an updated real time Cost Basis based on the portfolio metrics and characteristics;
(e) calculating a value of the Value Bank by subtracting the real time Cost Basis from the Combined Property Value;
(f) computing a nominal value of a Digital Asset Token by dividing the value of the Value Bank by a total number of Digital Asset Tokens;
(g) reporting a trading value of a Digital Asset Token based on trading data from one or more Exchanges supporting trading of the Digital Asset Token and potentially conversion of the Digital Asset Token into fiat currencies or other Digital Asset Tokens;
(h) providing a system, software and related technological support to facilitate trading of the Digital Asset Tokens, including, among other things, for compliance with regulatory (e.g., securities and tax) compliance; and
(i) adjusting and disseminating, on a real time basis over a Blockchain Network, acquisition information regarding Ground Leases whose Residual Values are added to the Value Bank.
